(19) United States
(12) Patent Application Publication
(10) Pub. No.: US 2010/0057488 A1
(43) Pub. Date: Mar. 4, 2010

(54) METHOD FOR DETERMINING MEDICAL TREATMENT VALUES WITHOUT DATA ENTRY

(76) Inventor: James B. Broselow, Hickory, NC (US)

Correspondence Address: ADAMS INTELLECTUAL PROPERTY LAW, Suite 2350 Charlotte Plaza, 201 South College Street, CHARLOTTE, NC, 28244, US

(21) Appl. No.: 12/203,218

(22) Filed: Sep. 3, 2008

(51) Int. Cl. G06Q 50/00

(52) U.S. Cl. 705/2

(57) ABSTRACT

A method of providing patient treatment values for predetermined medical treatments without the need for treatment value calculations at the time of treatment, including the steps of providing a database provided with predetermined categories of patient selection criteria and patient condition categories, determining treatment values for patients based on the selection criteria, entering the data into a database programmed to receive the treatment values correlated to the selection criteria at a time in advance of patient treatment, and for treating a patient, determining and selecting the appropriate patient selection criteria, determining and selecting a patient condition, wherein the database returns a treatment value correlated to the patient selection criteria.

### TECHNICAL FIELD AND BACKGROUND OF THE INVENTION

This invention relates to a method of determining medical treatment values without data entry. The method substantially speeds the determination of medical treatment values, permits determination at the bedside, and increases safety by avoiding the need to calculate dosages and dosage concentrations.

The use of computerized systems has become ubiquitous in the hospital environment. Original needs in the clinical areas related to improvement in documentation were originally the result of the need to achieve efficiencies as reimbursement from third party payers relied on adequate substantiation of services provided. At the same time there was increasing interest in reducing medical errors by the use of computer and bar coding technology to protect against giving medications to the wrong patient, not noting allergies, drug-drug reactions and salient laboratory data that might influence the choice and dosing of medications. By warning physicians with alerts at the time of entering data, order systems were intended to prevent such errors. In addition, such systems avoid problems resulting from misinterpretation of the handwriting of the prescribing physician.

Along with this approach to reducing errors and enhancing bedside information was the use of computerized programs to give clinical information of all sorts to health care providers. These programs are available by web based servers for use in computers and PDA's. They can also be downloaded directly. Their focus is to store a large amount of medical information, encyclopedic in nature, that can be accessed by navigating various links to find categories that can then be broken down into more specific information needed to focus on the particular query at hand. The dosing applications commonly built in calculators enable a patient's weight to be entered to give the appropriate medication dosage. They have other categories that allow selection of side effects, drug-drug interactions, etc., frequently utilizing further data entry. Epocrates is an example of such a widely used program for PDAs.

Although quite useful for retrieving medical information in certain clinical circumstances, their use in many other circumstances is not particularly helpful. A good example is the emergency administration of drugs or infusions as occurs in Emergency departments, ICU's and in the operating room. To safely administer a complex drug or infusion, it is necessary to know the dose of the medication, the amount of mLs of a given concentration that represent that dose, how the drug should be prepared and administered and the major side effects to be monitored or avoided. In addition, for safety reasons it is recommended that a second person check this information prior to administration. Because delay in administering life saving drugs is also considered an “error”, there is a paradox in that the time needed to find all of the appropriate information in the setting of an unstable patient needing acute intervention precludes the use of the standardized computerized information systems simply because such systems take too long to use, and frequently requires leaving the patient to refer to needed information, for example, in a book. Entering data into a computer and then utilizing that data to give medications is not a transparent process because others involved in the emergency patient care process cannot readily verify that the data was entered correctly and that the results are correct. The complexities of the present systems encourage “work arounds” whereby the systems are bypassed to get a more rapid or more easily obtained solution. Moreover, entering this type of data requires upper level non-automatic activities which interfere with critical thinking and also may require a person to be away from the bedside at a critical period in patient care.

There is a substantial need for a system of information that allows all relevant information for the administration of drugs at the bedside to be available to all members of the team in the “real time” requirements of an acute clinical encounter. In addition, such a system should be transparent to all members of the team that the information provided is correct and appropriate to that situation. There is also a need for a system as described above that has application both for adult and child administration.

### SUMMARY OF THE INVENTION

Therefore, it is an object of the invention to provide a system that permits the determination of medical treatment values without data entry.

It is another object of the invention to provide a system that permits the determination of medical treatment values at bedside, and in a manner that can be verified by others involved in medical care of the patient.

It is another object of the invention to provide a system that permits the determination of medical treatment values that includes administration instructions and techniques provided with the medical treatment value.

It is another object of the invention to provide a system that permits the determination of medical treatment values with a language that describes the clinical indication relating to each dose.

It is another object of the invention to provide a system that permits the determination of medical treatment values where multiple sources of information are distilled into a preferred source for the administration of a particular drug in a given clinical circumstance.

It is another object of the invention to provide a system that permits the determination of medical treatment values where all of that information is presented in a standard format allowing rapid orientation to content.

It is another object of the invention to provide a system that permits the determination of medical treatment values where standard formats are stored as a graphic unit and accessed as a whole with only one or two keystrokes to allow rapid access.

It is another object of the invention to provide a system that permits the determination of medical treatment values where all data is pre-determined and easily verified by all members of a clinical team.

It is another object of the invention to provide a system that permits the determination of medical treatment values to be displayed at the bedside or the operating room with access preferably by touch screen and a large computer display.

It is another object of the invention to provide a system that permits the determination of medical treatment values with a system that is uploaded with text indicia rather than calculated indicia.

These and other aspects of the invention are provided in a method of providing patient treatment values for predetermined medical treatments without the need for treatment value calculations at the time of treatment, includes the steps of providing a database provided with predetermined categories of patient selection criteria and patient condition categories, and determining treatment values for patients based on the selection criteria. The data is entered into a database programmed to receive the treatment values correlated to the selection criteria at a time in advance of patient treatment. To treat a patient, the patient selection criteria is determined and selected, a patient condition is etermined and selected, and the database returns a treatment value correlated to the patient selection criteria.

According to one embodiment of the invention, the predetermined categories of patent selection criteria are patient body weight ranges.

According to another embodiment of the invention, the predetermined categories of patent selection criteria are a range of selectable different colors.

According to another embodiment of the invention, the predetermined categories of patent selection criteria are arranged in rows and the patient condition categories are arranged in columns.

According to another embodiment of the invention, the treatment values are selected from the group consisting of equipment sizes, drug dosages, drug dosage prescribing and sequencing values.

According to another embodiment of the invention, the method includes the step of programming the database to white out columns containing non-selected patient selection criteria.

According to another embodiment of the invention, the method includes the step of providing an entry screen that allows entry into a desired patent condition category with a single selection activity.

According to another embodiment of the invention, the predetermined categories of patent selection criteria are the predetermined patient condition categories selected from the group consisting of Resuscitation, Infusions, Anaphylaxis, RSI, Seizures, Respiratory Medicines, Fluid and Blood Therapy, Rehydration Therapy, Electrolyte Therapy, D.A., Burns and Toxicology.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a representation of the Entry Screen, which may be a Quick Reference Equipment Chart, as shown;

FIG. 2 is a representation of a Dehydration Therapy Chart showing data for Moderate Dehydration;

FIG. 3 is a representation of a Chart showing treatment steps for Anaphylaxis;

FIG. 4 is a representation of a Chart showing Oral Rehydration Therapy for Moderate Dehydration;

FIG. 5 is a representation of a Burn Therapy Chart for a patient weighing between 12-14 kg.;

FIG. 6 is a representation of a General Sequence for Rapid Sequence Induction resuscitation;

FIG. 7 is a representation of a Chart showing the treatment sequence and dosages for Resuscitation of a patient with Tachycardia and poor perfusion;

FIG. 8 is a representation of a Chart showing the treatment sequence and dosages for Seizures;

FIG. 9 is a representation of a Chart showing Seizure Resuscitation using Lorazipam;

FIG. 10 is a representation of a Chart showing IV rehydration therapy steps;

FIG. 11 is a representation of a Chart showing Seizure with absent pulseless arrest;

FIG. 12 is a representation of a Chart showing drug dosages and instructions for resuscitation using Amiodarone Reference IV;

FIG. 13 is a representation of a Chart showing drug dosages and instructions for treating a seizure using Fosphenytoin Loading IV; and

FIG. 14 is a representation of a Chart showing equipment selection for a Patient weighing between 12-14 kg, where the values for other weight ranges/colors are whited out.

### DESCRIPTION OF THE PREFERRED EMBODIMENTS AND BEST MODE

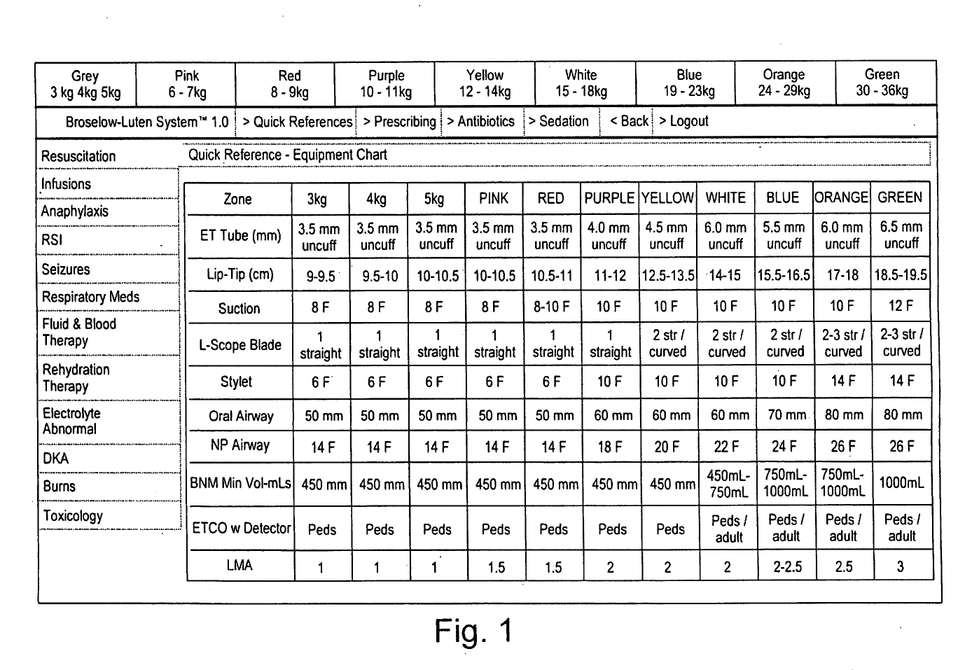

Referring now specifically to the drawings, an entry screen is shown In FIG. 1 that permits the user to quickly determine a selected one of many values. The values are entered into the system as text during system development and maintenance. The system contains no values that are calculated by the system or that must be entered by the user during patient treatment. This prevents miscalculated values resulting from hasty, careless or mistaken data entry. The text values are entered, double-checked and verified in a controlled, non-patient, stress-free environment. The user is thus freed from the task of remembering and correctly entering values in an emergency situation.

The system is thus passive and user-friendly, highly graphical and operates in real time. Standardized formatting means that the user can quickly become familiar with the layout, thus further increasing speed and accuracy.

The application shown is a system particularly adapted for use in pediatric emergency situations commonly found in hospital emergency rooms and in EMS facilities or vehicles. Color-coding is used but is not essential. The system is essentially weight-based, but can be based on length correlated to lean body mass. In the application illustrated in FIG. 1, the user may start on the entry screen by picking a category, such as “resuscitation” based on the immediate observation by the user of the patient's condition and the needed intervention and “clicking” on the “Resuscitation” Category. The system may be further entered by knowing that the patient is a coded “purple”, or may weigh or estimate the weight of the patient without regard to color coding. Clicking on the “Purple” box at the top of the chart immediately opens a table. Knowing the “color” of the patient, i.e., purple, yellow, etc., permits a wide range of treatment selections to be made without calculations, weight or age estimates.

FIG. 1, as well as being the entry screen, is a representation of the Quick Reference Equipment Chart. Note that the “Grey” zone is subdivided into three separate weight categories suitable for neonates. The first three columns of equipment sizes therefore provide very precise equipment sizes and related values. This Chart is obtained directly from the entry page, FIG. 1, and permits rapid entry into the data fields. Access in the first instance is by selecting the color/weight range of the patient. In one variation, all of the columns except for the column of the selected color/weight range are whited out so that there can be no possibility of reading values from the wrong column.

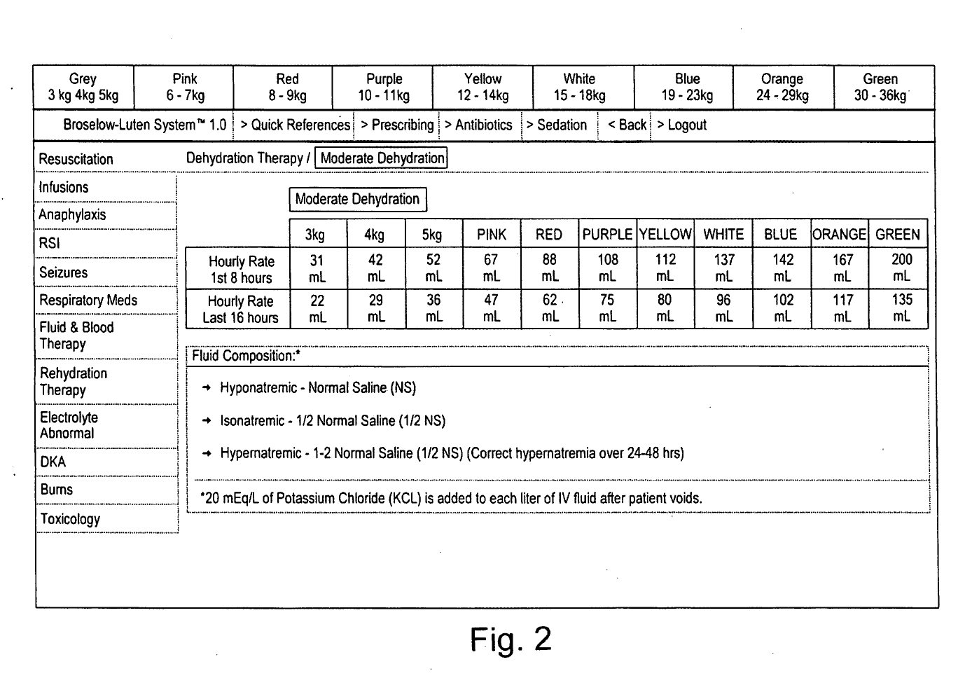

FIG. 2 is a representation of a Dehydration Therapy Chart showing data for Moderate Dehydration. Again, the first three columns of “Grey” provide very precise administration rates, as well as rehydration fluid composition and treatment instructions.

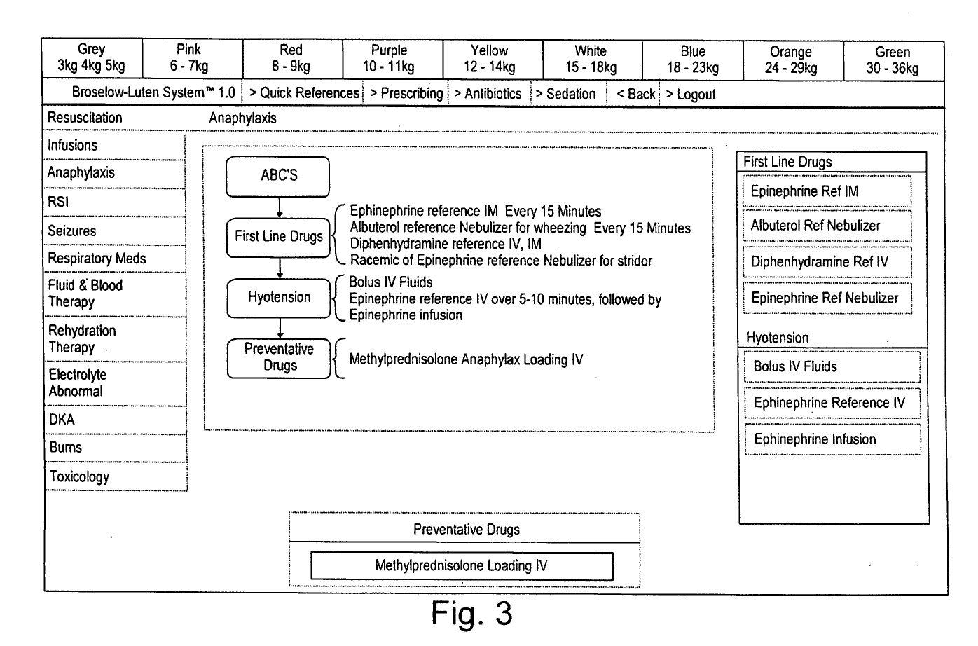

FIG. 3 is a representation of a Chart showing treatment steps for Anaphylaxis. Basic treatment procedures and sequences are provided, along with drugs to be used. Selecting a drug from the right-hand side of the chart provides further information, including administration procedures and contraindications.

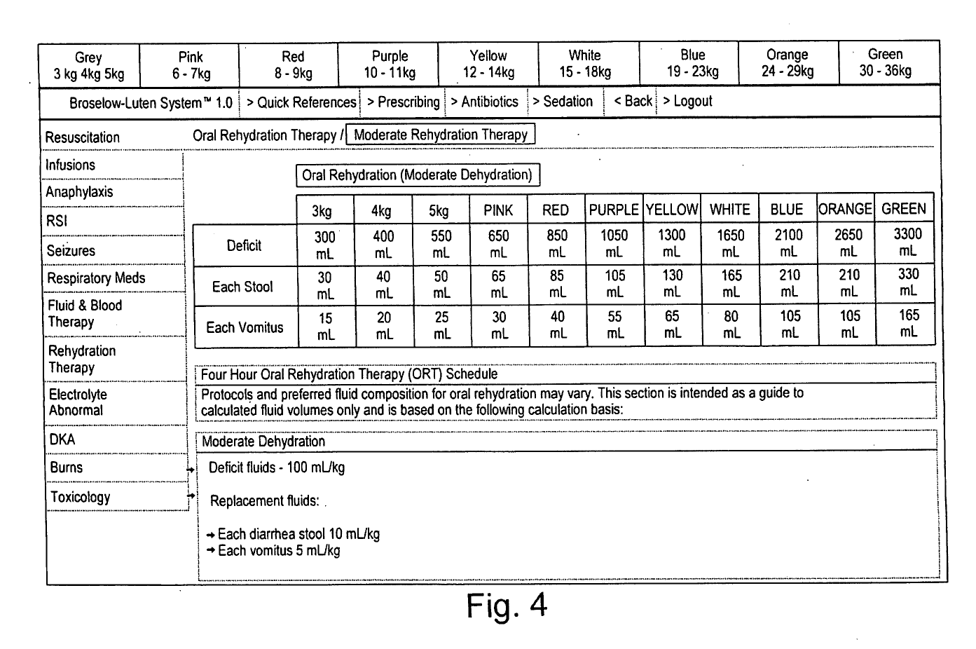

Referring now to FIG. 4, a representation of a Chart showing Oral Rehydration Therapy for Moderate Dehydration is shown. Virtually all of the required information is on a single page with no need for calculation. Selecting “Purple” for example, provides deficit, stool and vomitus replacement values for each color/weight range.

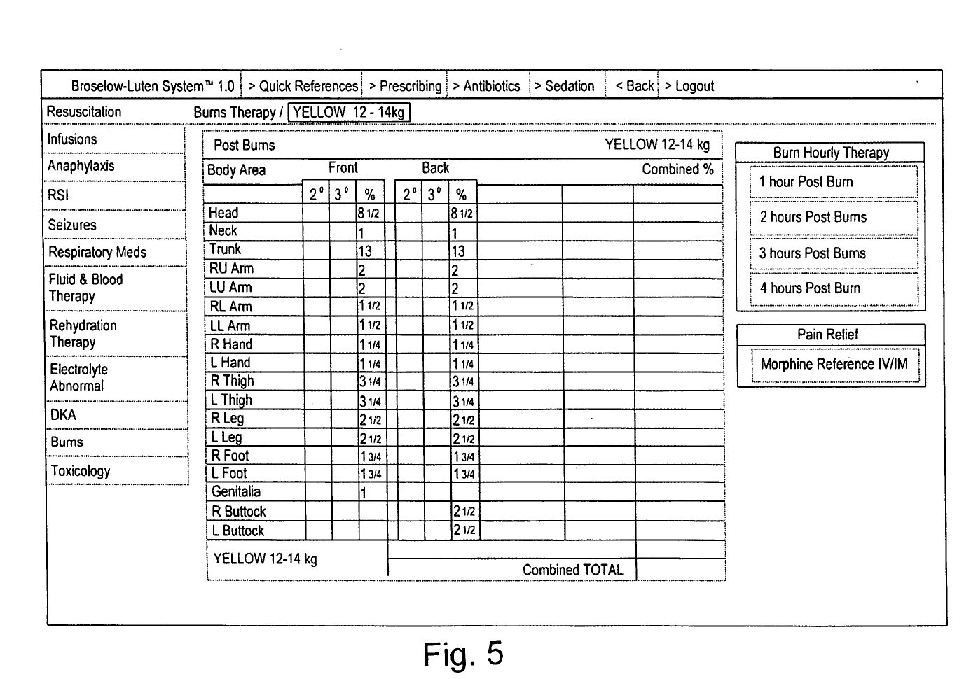

FIG. 5 is a representation of a Burn Therapy Chart for a patient weighing between 12-14 kg. Accordingly, the color “Yellow” has been selected and the burn percentages for selected body parts are set out. This page was selected by pointing to the “Burns” button near the bottom of the left-hand column. Clicking the buttons on the right permits treatments for various time intervals after trauma to be determined, as well as the appropriate morphine dosage.

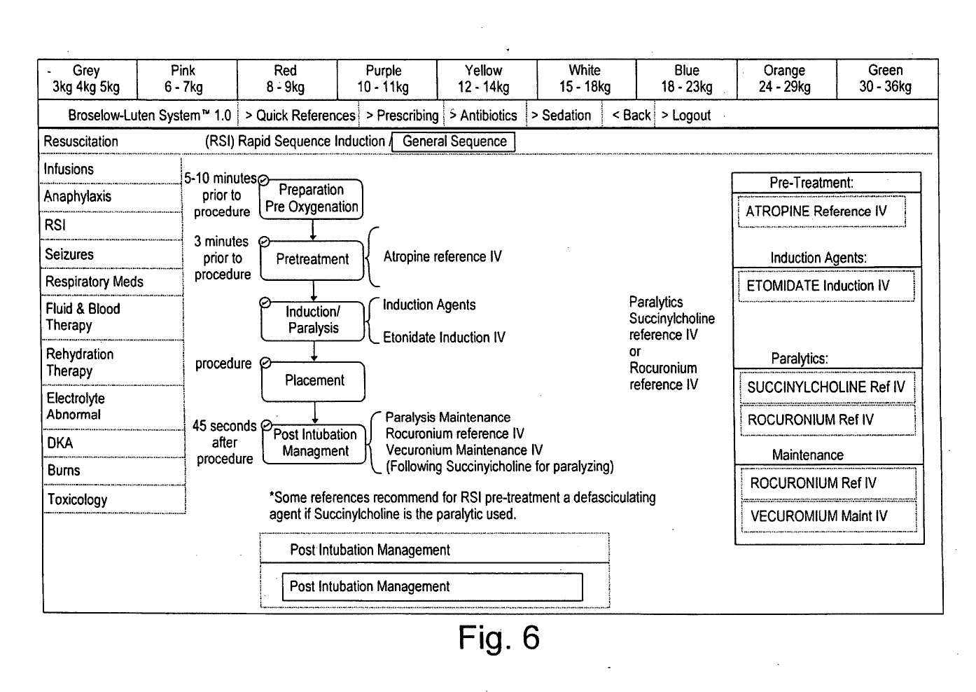

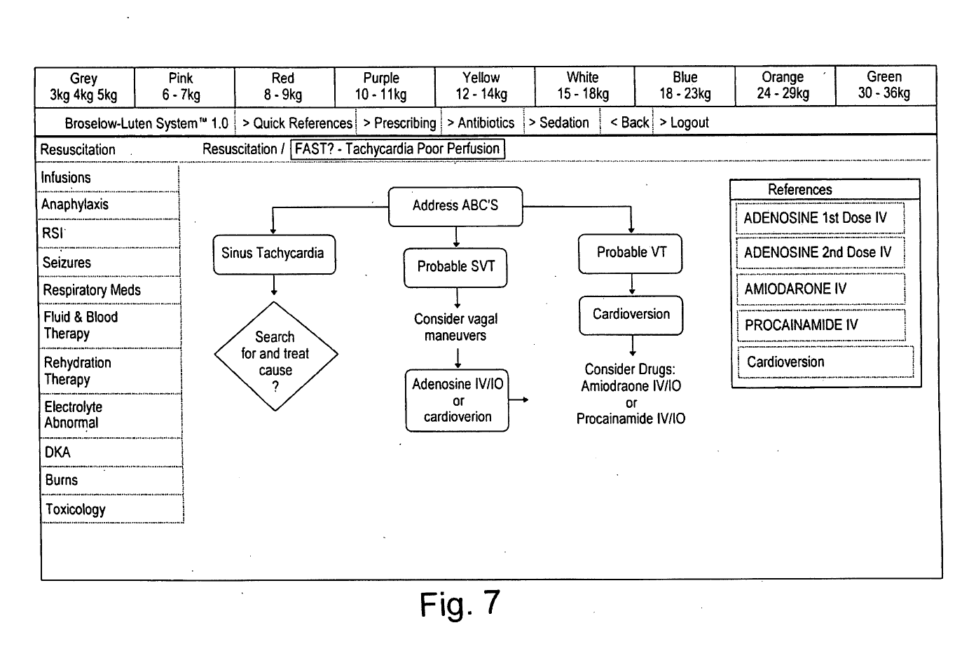

Referring now to FIG. 6, a representation of a General Sequence for Rapid Sequence Induction Resuscitation is shown, and includes the treatment sequence and buttons on the right-hand side of the page for additional information regarding drugs most often administered, and FIG. 7 is a representation of a Chart showing the treatment sequence and dosages for Resuscitation of a patient with Tachycardia and poor perfusion.

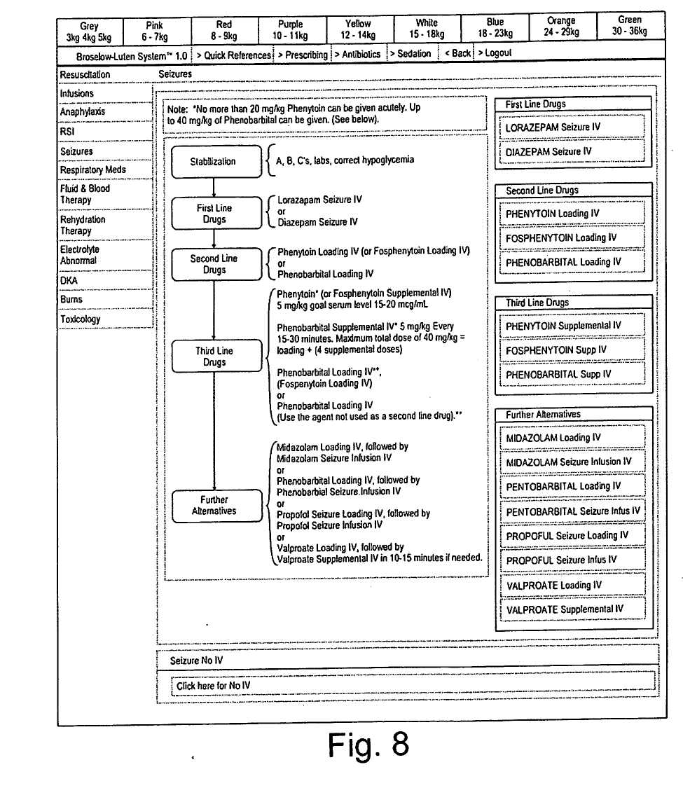

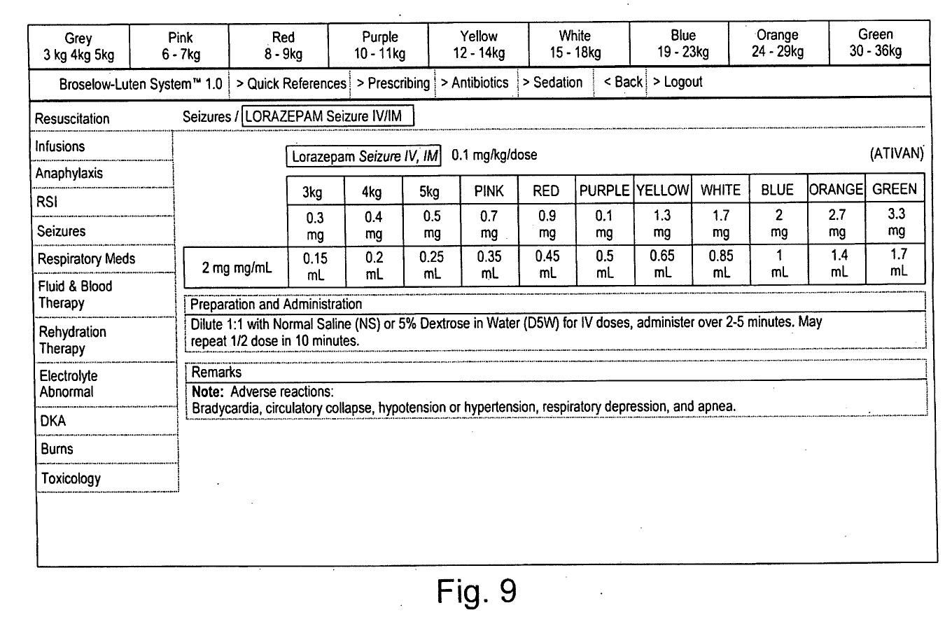

Referring to FIG. 8, a treatment sequence with drug alternatives is shown. By clicking on one of the button selections on the right-hand side of the page, further information regarding each drug can be found. For example, by selecting Lorazepam on FIG. 8, the page shown in FIG. 9 opens, and allows a color/weight selection to be made and the correct dosage for that weight patient can be quickly determined without calculation. As shown, the correct dosage using Lorazepam Seizure IV, intramuscular at 0/1 mg/kg/dose is determined by simply reading the value from the correct column. As previously noted, the system can be set to white out all values except those for the selected color/weight. In FIG. 8, if no IV is desired, the bar at the bottom of the page is clicked, and the screen changes to provide a treatment sequence excluding IV administration.

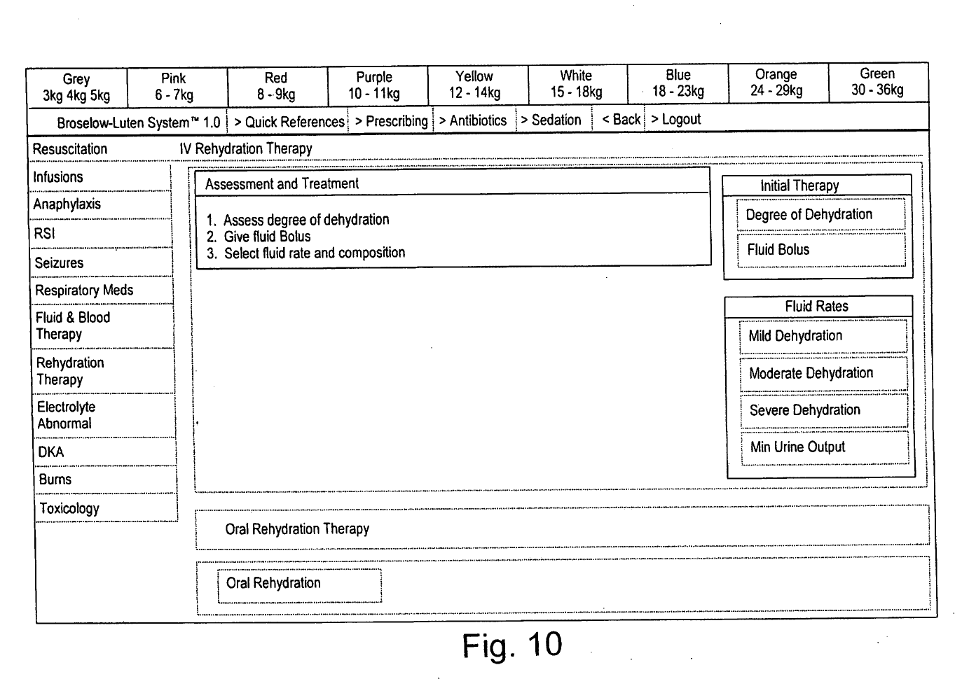

FIG. 10 is a representation of a Chart showing IV rehydration therapy steps.

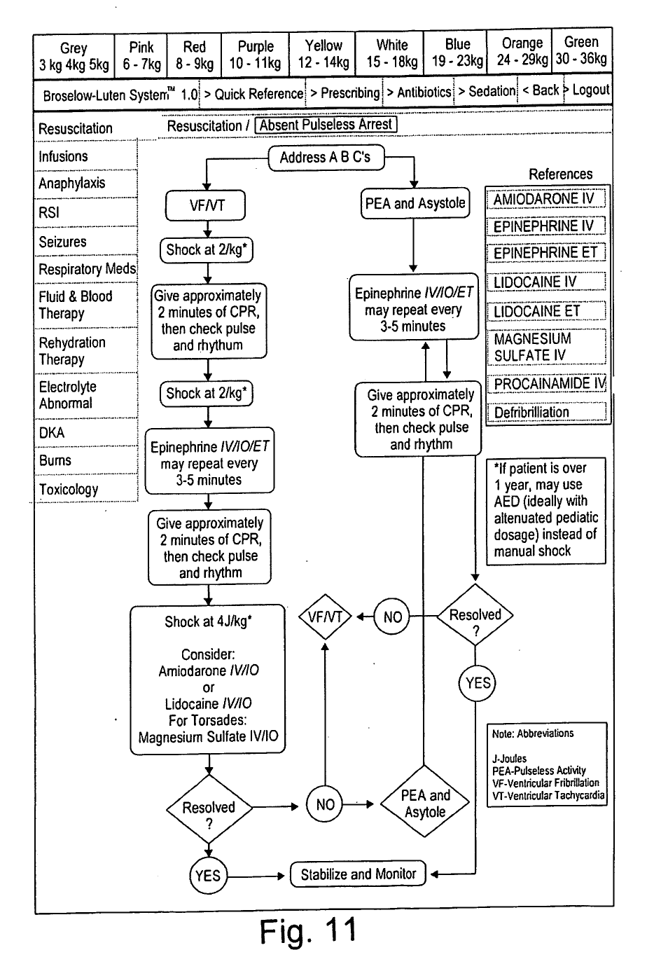

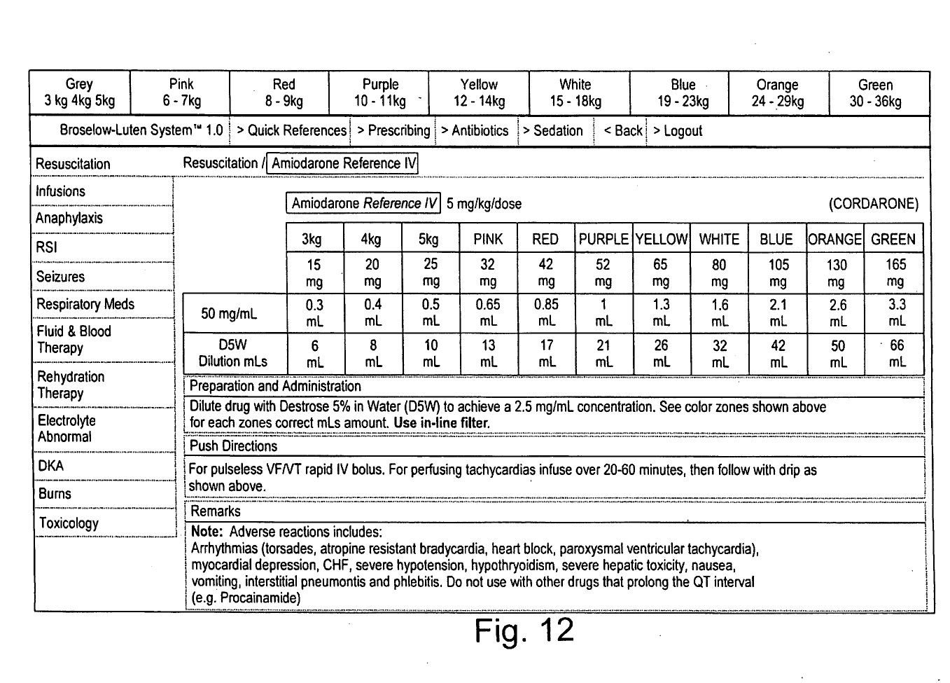

FIG. 11 is a representation of a Chart showing Seizure with absent pulseless arrest. If Amiodarone IV button is selected on the right-hand side of the page, the chart shown on FIG. 12 opens, showing drug dosages and instructions for resuscitation using Amiodarone Reference IV.

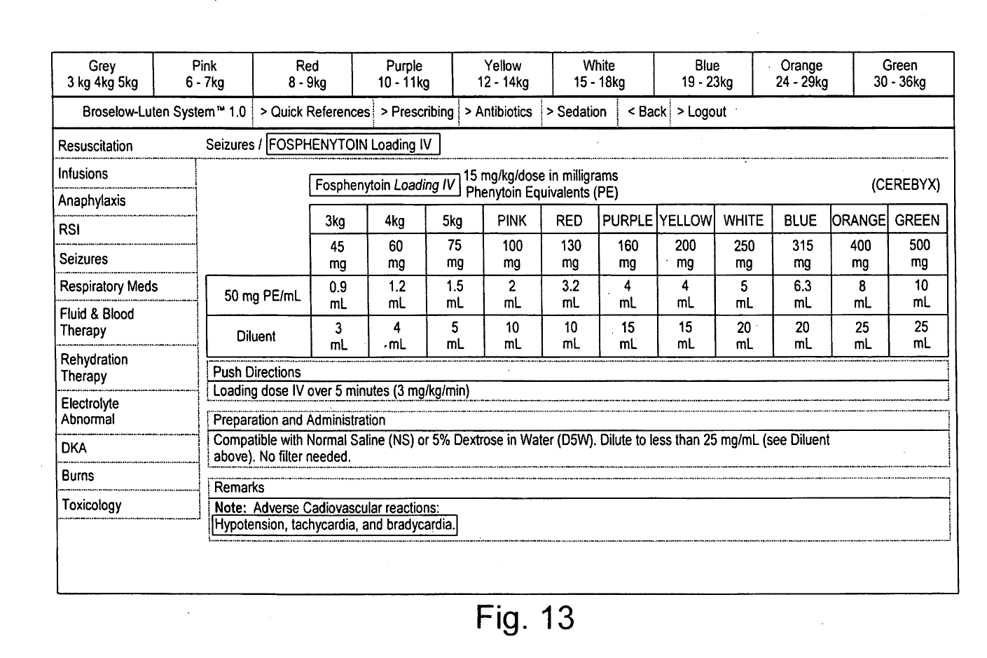

FIG. 13 is a representation of a Chart showing drug dosages and instructions for treating a seizure using Fosphenytoin Loading IV.

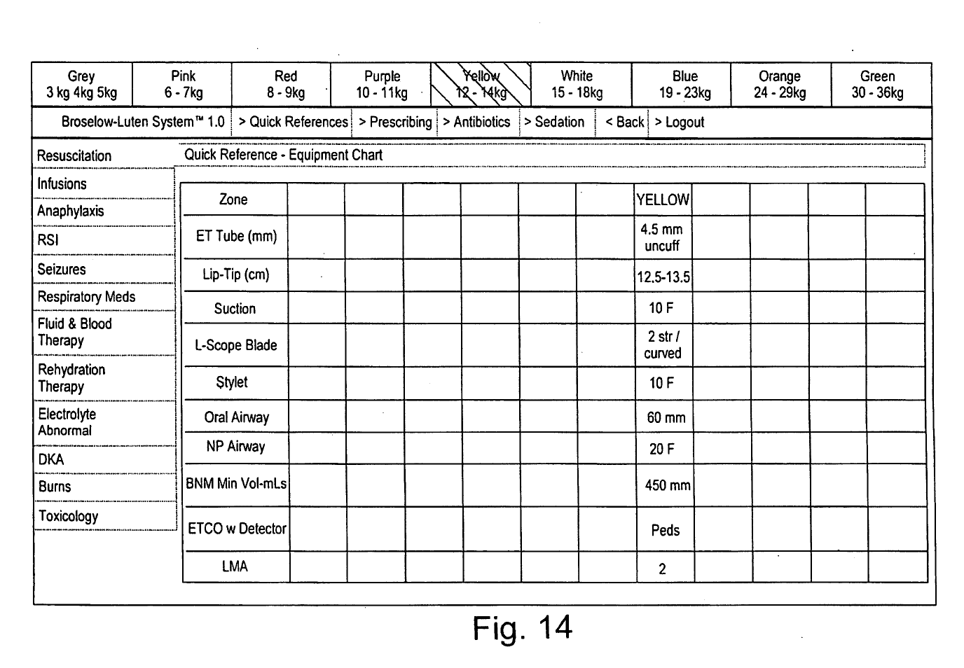

As is shown in FIG. 14, the screens may be designed so that when a particular weight/color is selected, the non-selected weights/colors are whited out. In FIG. 14, a patient weighing between 12-14 kg is selected, and the other columns are whited out to prevent misreading of data resulting from looking at the wrong column.

The invention is further explained with reference to the following examples:

### EXAMPLE 1

Assumption: presenting patient is a child having a weight of 11 Kg and is not breathing.

Go to opening menu screen:
1) Click color/weight corresponding to 11 Kg—purple;
2) Click “Resuscitation” on left side of screen;
3) Click on drug directly if known, e.g epinephrine;
4) Get information from color grid.

### Or

1) Click color/weight corresponding to 11 Kg—purple;
2) Click “Resuscitation” on left side of screen;
3) Click on flow chart (bradycardia for slow pulse);
4) Follow the clinical guidelines;
5) Click on indicated drugs, Joules, etc.
   Switch to other flow charts for rapid pulse, etc. as needed by the clinical situation.

As is evident from the foregoing, no calculations need be made. The only information needed is the approximate weight of the patient so that the appropriate one of the provided array of colors can be selected. From then on, the care provider can determine equipment sizes, drug dosages, administration procedures, and treatment sequencing without leaving the patient to consult books or calculate or convert drug dosage values.

### EXAMPLE 2

Assumption: presenting patient is a child having a weight of 11 Kg and is having a seizure caused by, for example, low blood sugar, infection, head injury, accidental poisoning, or drug overdose

Go to opening menu screen:
1) Click color/weight corresponding to 11 Kg—purple;
2) Click “seizures” on left and select drugs and click links as above;
3) Click on drug directly if known;
4) Get information from color grid.

### Or

1) Click color/weight corresponding to 11 Kg—purple;
2) Click “Seizure” on left side of screen;
3) Click on flow chart;
4) Follow the clinical guidelines;
5) Click on indicated drugs, as needed.

A method of determining medical treatment values improved is described above. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims.

I claim:

1. A method of providing patient treatment values for predetermined medical treatments without the need for treatment value calculations at the time of treatment, comprising the steps of:
(a) providing a database provided with predetermined categories of patient selection criteria and patient condition categories;
(b) determining treatment values for patients based on the selection criteria;
(c) entering the data into a database programmed to receive the treatment values correlated to the selection criteria at a time in advance of patient treatment; and
(d) for treating a patient, determining and selecting the appropriate patient selection criteria, determining and selecting a patient condition, wherein the database returns a treatment value correlated to the patient selection criteria.

2. A method according to claim 1, wherein the predetermined categories of patent selection criteria comprise patient body weight ranges.

3. A method according to claim 1, wherein the predetermined categories of patent selection criteria comprise a range of selectable different colors.

4. A method according to claim 1, wherein the predetermined categories of patent selection criteria are arranged in rows and the patient condition categories are arranged in columns.

5. A method according to claim 1, wherein the treatment values are selected from the group consisting of equipment sizes, drug dosages, drug dosage prescribing and sequencing values.

6. A method according to claim 1, wherein the method includes the step of programming the database to white out column containing non-selected patient selection criteria.

7. A method according to claim 1, and including an entry screen that allows entry into a desired patent condition category with a single selection activity.

8. A method according to claim 1, wherein the predetermined patient condition categories are selected from the group consisting of Resuscitation, Infusions, Anaphylaxis, RSI, Seizures, Respiratory Medicines, Fluid and Blood Therapy, Rehydration Therapy, Electrolyte Therapy, D.A., Burns and Toxicology.

9. A method of providing patient treatment values for predetermined medical treatments without the need for treatment value calculations at the time of treatment, comprising the steps of:
(a) providing a database provided with predetermined categories of patient selection criteria and patient condition categories, wherein the predetermined categories of patent selection criteria comprise patient body weight ranges or a range of selectable different colors arranged in rows and the patient condition categories are arranged in columns;
(b) determining treatment values for patients based on the selection criteria, wherein the treatment values are selected from the group consisting of equipment sizes, drug dosages, drug dosage prescribing and sequencing values;
(c) entering the data into a database programmed to receive the treatment values correlated to the selection criteria at a time in advance of patient treatment; and
(d) for treating a patient, determining and selecting the appropriate patient selection criteria, determining and selecting a patient condition, wherein the database returns a treatment value correlated to the patient selection criteria and whites out columns containing non-selected patient selection criteria.

10. A method according to claim 9, and including an entry screen that allows entry into a desired patent condition category with a single selection activity.

11. A method according to claim 10, wherein the predetermined patient condition categories are selected from the group consisting of Resuscitation, Infusions, Anaphylaxis, RSI, Seizures, Respiratory Medicines, Fluid and Blood Therapy, Rehydration Therapy, Electrolyte Therapy, D.A., Burns and Toxicology.
